(19) United States
(12) Patent Application Publication
(10) Pub. No.: US 2008/0256582 A1
(43) Pub. Date: Oct. 16, 2008

(54) Method For Viewing the Content of a Dvb-H Type Digital Television Signal

(76) Inventor: Bertrand Mazieres, Nancy (FR)

Correspondence Address: MICHAEL BEST & FRIEDRICH LLP, 100 E WISCONSIN AVENUE, Suite 3300, MILWAUKEE, WI, 53202, US

(21) Appl. No.: 12/090,742

(22) PCT Filed: Oct. 18, 2006
(86) PCT No.: PCT/FR2006/002339

§ 371 Date: Apr. 18, 2008

(30) Foreign Application Priority Data
Oct. 19, 2005 (FR) 0510640

(51) Int. Cl. H04N 7/173

(52) U.S. Cl. 725/105

(57) ABSTRACT

The invention relates to a method of visualizing the content of a DVB digital TV signal comprising a plurality of transport streams in which each TS packet is identified by a packet identifier (PID) corresponding to a respective program or service, the method being characterized in that it implements a display in the form of a two-dimensional graph in which the first dimension represents time and the second bit rate, showing successive bars of graphics symbols stacked parallel to the second dimension, each bar representing a stack of said graphics symbols in which each symbol represents a TS packet, each graphics symbol being distinguished as a function of the stream to which the packet belongs. The method orders the packets of each bar so as to group packets together by stream.

### BACKGROUND OF THE INVENTION

The present invention relates to a method of visualizing the content of a digital TV channel of the DVB type, and in particular of the DVB-H type, in order to enable the validity of the signal to be monitored in real time.

The DVB-H standard makes use of MPEG2 transport streams (TS) with the streams being subjected to time slicing.

That type of time-slice organization and the addition of a code for multiprotocol encapsulation forward error correction (MPE FEC) implies implementing appropriate means for verifying that the transmitted signal is valid.

### SUMMARY OF THE INVENTION

An object of the present invention is to provide a method that is simple, fast, and inexpensive for verifying the validity of a DVB-H stream at different positions within a transmission system, and in particular for verifying that each of the elements in the system taken individually does not endanger the validity of the signal.

The invention thus provides a method of visualizing the content of a DVB digital TV signal, in particular of the DVB-H, DVB-T, DVB-S, or DVB-C type, comprising a plurality of transport streams in which each TS packet is identified by a packet identifier (PID) corresponding to a respective program or service, the method being characterized in that it implements a display in the form of a two-dimensional graph in which the first dimension represents time and the second bit rate, showing successive bars of graphics symbols stacked parallel to the second dimension, each bar representing a stack of said graphics symbols in which each symbol represents a TS packet, each graphics symbol being distinguished as a function of the stream to which the packet belongs. The method may order the packets in each bar so as to group packets together by stream.

This thus obtains an overall technical result, namely monitoring of each of the streams and possibly also of the total bit rate relative to the authorized maximum bit rate.

Advantageously, the invention eliminates null packets.

The graphics symbols are distinguished, for example, by associating a color with each of the signal streams.

Advantageously, the display provides an indication of an authorized maximum bit rate.

The method may implement the display for at least one stream of an MPE FEC corrector code. This visualization is advantageously implemented using the same color as for the other packets of said stream, but with a different shade.

### BRIEF DESCRIPTION OF THE DRAWINGS

Other characteristics and advantages of the invention appear better on reading the following description with reference to the drawings, in which:

FIG. 1 shows a DVB-H signal coexisting with a DVB-T signal (without time slicing) in the same multiplex, as is permitted by the standard;

FIG. 2 shows a graphic display of the DVB-H signal (with color differences being represented in this figure and the following figures merely by different gray levels);

FIG. 3 shows a display of the invention associating a color with each stream after ordering the packets of each column by their PID identifiers and eliminating null packets;

FIG. 4 shows a display of the invention in which the streams corresponding to FEC codes are represented separately in different shades of color,

FIG. 5 showing a simple case in which there are three services;

FIG. 6 shows a display of a DVBT/H multiplex; and

FIGS. 7a and 7b show a graph display of the DVB-H signal and the same display after null packets have been eliminated.

### DETAILED DESCRIPTION

The services of a DVB-H multiplex are provided in the form of TS packets having a length 188 bytes that are identified by a packet identifier PID indicating, amongst other things, the program or service to which the packet belongs.

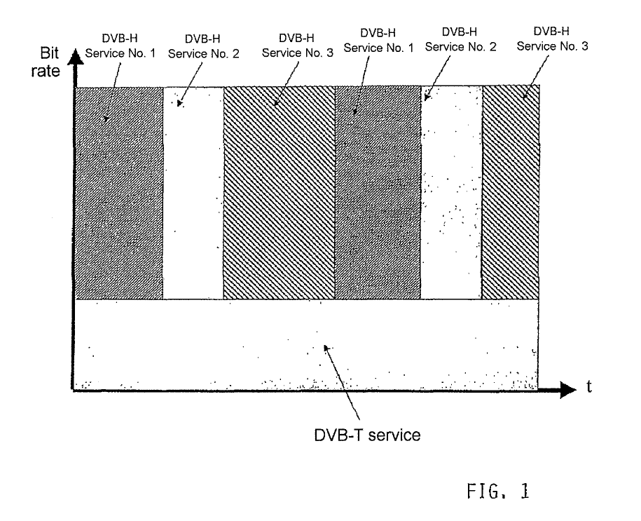

The multiplex shown in FIG. 1 comprises a first service that is a DVB-T service (without time slicing, i.e. transmitted continuously), and three services Nos. 1, 2, and 3 that are DVB-H services and that are transmitted in turn (i.e. with time slicing). The purpose of such time slicing is specifically to reduce the reception time of a mobile receiver and thus economize the electrical energy in the batteries of the receiver, since it needs to remain in receive mode only while receiving the service or program that interests it, putting itself into rest mode the remainder of the time, while the other services or programs are being transmitted.

The present invention relates to visualizing the services of a DVB-H multiplex that are being transmitted with time slicing, whether or not they coexist with one or more DVB-T services.

Each 188-byte TS packet is represented by one symbol, e.g. a rectangle, having a display parameter, e.g. color, that varies as a function of the PID stream identifier in a graph having time in seconds as its abscissa and bit rate in megabits per second (Mbps) as its ordinate. Each column is the result of accumulating the packets received during a given time interval, thereby enabling the bit rate to be read off directly since it is proportional to the number of packets per unit time.

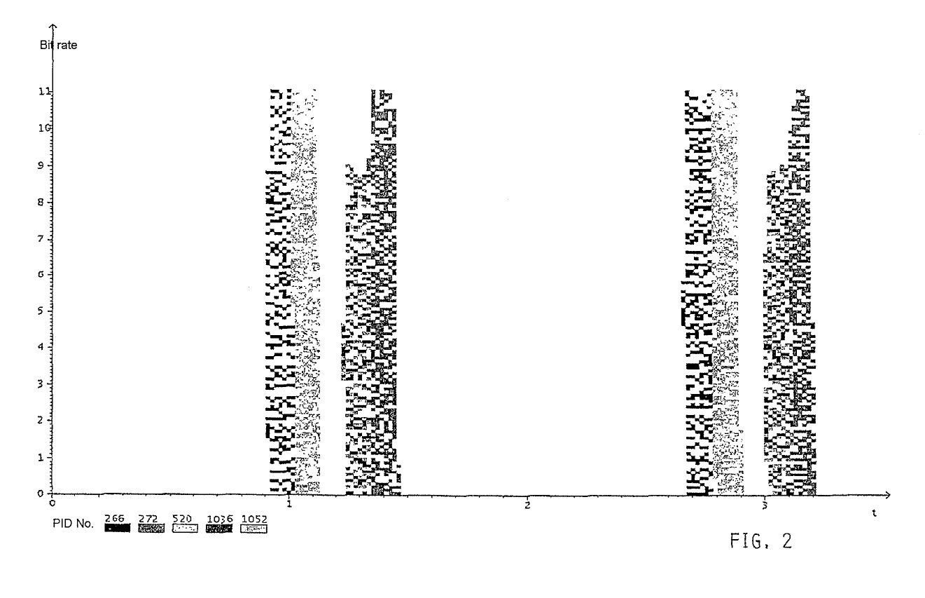

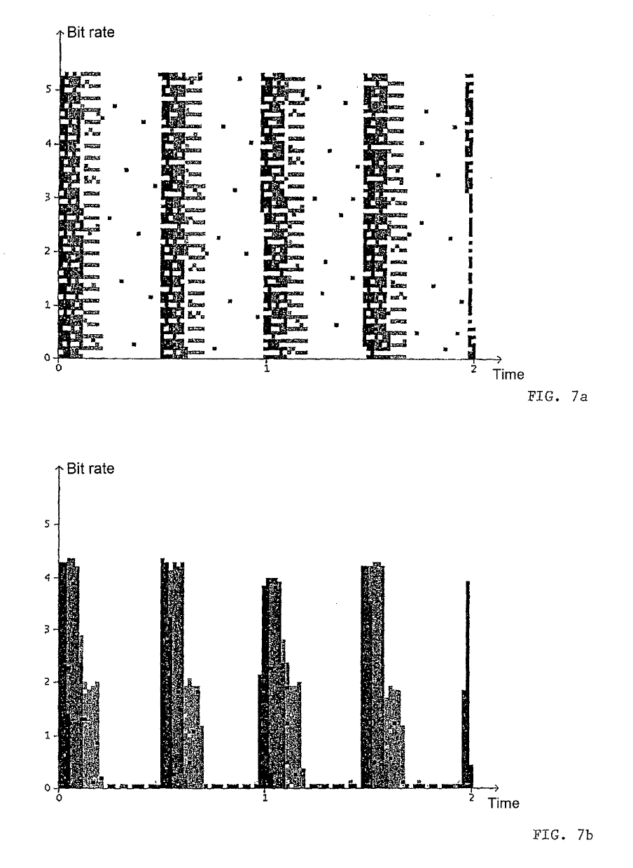

One such “raw” representation is shown in FIG. 2. It can be seen that it does not enable the stream to be analyzed “at sight”. The representation of FIG. 2 can be improved by eliminating null packets (without ordering the packets by their stream identifiers PID). This enables signals to be visualized as they arrive. FIGS. 7a and 7b show respectively a raw representation (of the kind shown in FIG. 2) in a configuration where the packets of each stream do not all arrive in stream order, and the same representation after null packets have been eliminated.

To enable the streams to be analyzed “at sight”, the packets in each column are ordered by their stream identifiers PID, i.e. corresponding to the same program or service.

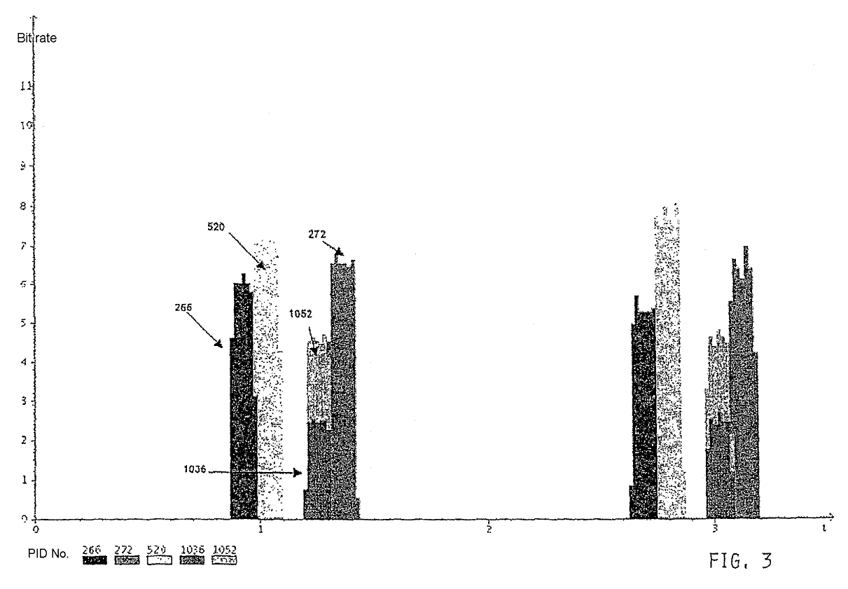

This representation is shown in FIG. 3, for DVB-H streams 266, 272, 520, 1036, and 1052, and it makes it possible to visualize immediately the stream corresponding to each program or service, and also its presence after passing through a piece of equipment or a transmission system. For clarity in visualization, null packets are eliminated.

This representation also makes it possible to verify the time between two bursts of packets having the same color and corresponding to the same program or service.

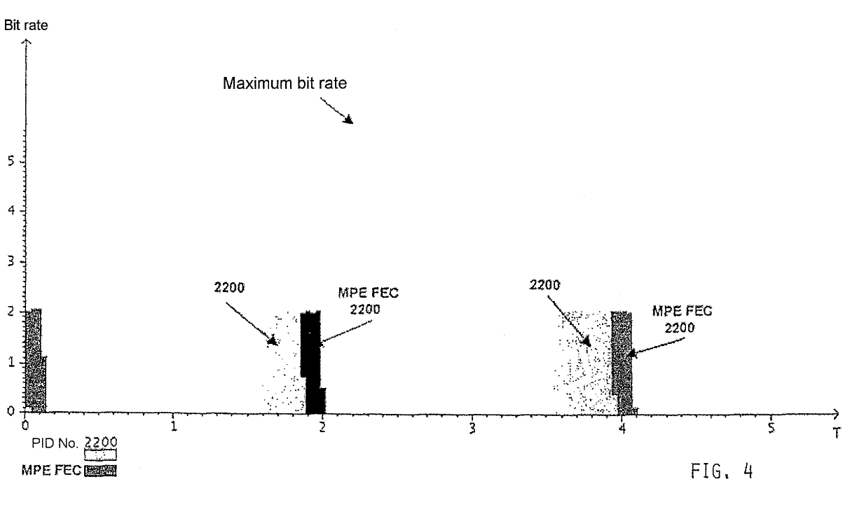

When a PID stream contains packets including an MPE FEC corrector code, they can be displayed using the same color, but with a different shade, e.g. darker, as shown in FIG. 4 for the DVB-H stream No. 2200.

FIG. 4 also shows a horizontal line representing the maximum authorized bit rate calculated simply by observing the number of 188-byte packets in a given time interval. This line makes it possible to see that the multiplex is not overflowing, since none of the columns reaches this maximum bit rate line.

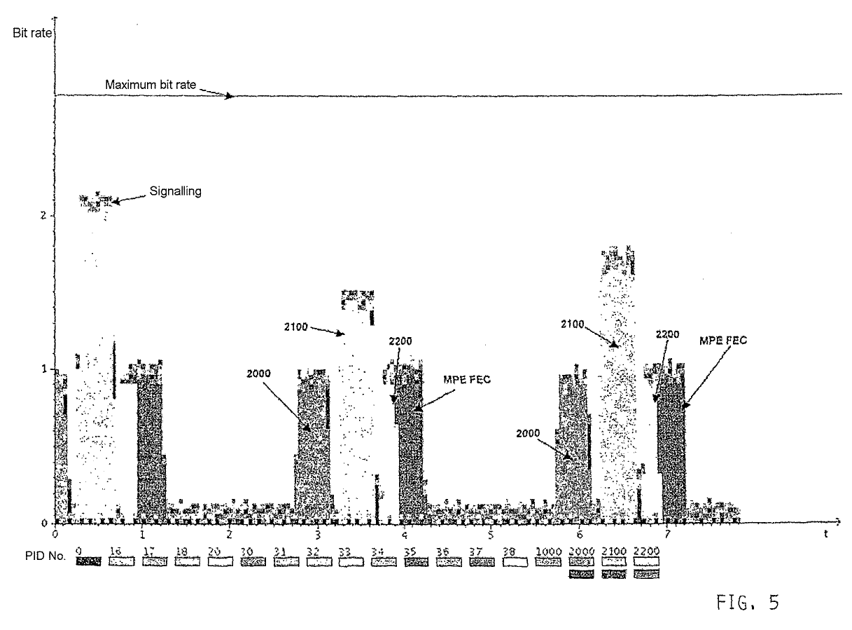

The other TS packets, e.g. those containing PSI/SI signaling data, are displayed in the form of graphics symbols, using a shade of the color corresponding to the PID streams to which these packets relate. This display is preferably marked at the tops of the columns of graphics symbols (and between the columns, where appropriate), as shown in FIG. 5.

FIG. 5 shows a display of a DVB-H multiplex corresponding to three PID streams Nos. 2000, 2100, and 2200. Filtering the PID streams makes it possible to display only three DVB-H streams, together with all of the signaling.

It is possible to select which services are displayed by conserving only those TS packets for which the PID identifiers correspond to said selected service. The selected services can be selected to be constituted solely by DVB-H services, i.e. services that are time sliced. This distinguishing of DVB-H services can be performed by packet frame analysis, for example.

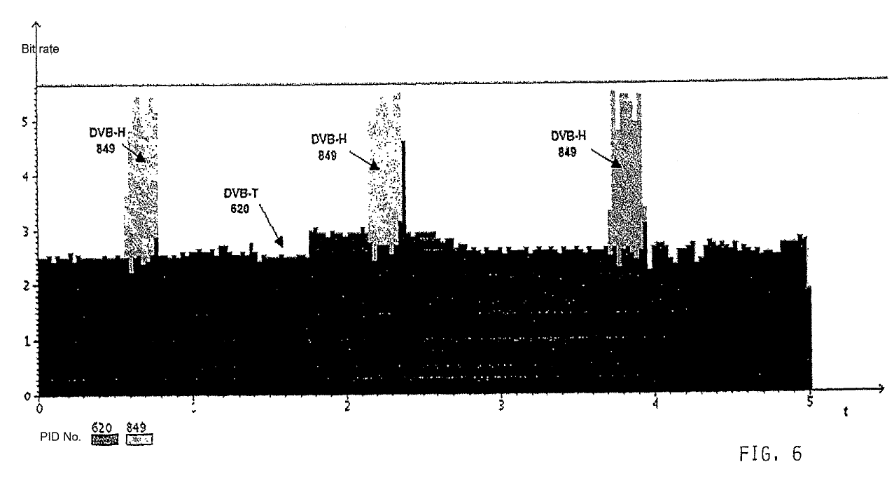

FIG. 6 shows a display of a DVBT/H multiplex associating a DVB-T stream (620) with a DVB-H stream (849). Starting from the abscissa, it can be seen that the graphics symbols of the DVB-T stream(s) are displayed initially and that they are surmounted by the peaks corresponding to the DVB-H stream(s) of the multiplex. For the DVB-T stream, graphics symbols similar to those used for the DVB-H display are stacked, thereby making it possible to maintain the same scale for bit rate.

The method of the invention can be used to deliver one or more alarms, in particular: an alarm in the absence of a service, i.e. in the absence of a PID identifier for one or more given services, during a given number of packet bursts or cycles (e.g. 2 to 10 cycles); and/or an alarm in the event of at least one service overflowing a determined bit rate value.

1. A method of visualizing the content of a DVB digital TV signal comprising a plurality of transport streams in which each TS packet is identified by a packet identifier (PID) corresponding to a respective program or service, the method comprising implementing a display in the form of a two-dimensional graph wherein the first dimension represents time and the second bit rate, and showing successive bars of graphics symbols stacked parallel to the second dimension, wherein each graphics symbol represents one TS packet and is displayed as a function of the stream to which the packet belongs.

2. A method according to claim 1, further comprising ordering the packets in each bar so as to group packets together by stream.

3. A method according to claim 1 further comprising eliminating null packets.

4. A method according to claim 1, further comprising associating a respective color with each stream.

5. A method according to claim 1, wherein the program or service is a DVBT/H program or service the method further comprising associating at least one DVB-T stream with at least one DVB-H stream, and displaying the graphics symbols of the at least one DVB-T stream before the graphics symbols of the at least one DVB-H stream.

6. A method according to claim 1 further comprising indicating a maximum authorized bit rate.

7. A method according to claim 1, wherein at least one stream includes an MPE FEC corrector code.

8. A method according to claim 7, further comprising associating a first shade of a respective color with each stream and displaying the MPE FEC corrector code in a second shade of the respective color associated with the stream.

9. A method according to claim 1, further comprising selecting a service to be displayed and filtering the TS packets to display only those for which the packet identifiers (PIDs) correspond to the selected services.

10. A method according to claim 9, wherein the selected service includes a DVB-H service.

11. A method according to claim 10, further comprising distinguishing the packets corresponding to the DVB-H service by packet frame analysis.

12. A method according to claim 1, further comprising issuing an alarm if the PID identifier is absent for the respective service during a predetermined number of successive cycles.

13. A method according to claim 12, wherein the predetermined number of successive cycles is selected from between two and ten.

14. A method according to claim 1, further comprising issuing an alarm if the packets corresponding to the respective service exceed a determined bit rate value.
